(19) United States
(12) Patent Application Publication
(10) Pub. No.: US 2010/0065342 A1
(43) Pub. Date: Mar. 18, 2010

(54) TOUCH SCREEN HAVING REDUCED REFLECTION

(75) Inventor: Mohammed Saleem Shaikh, Santa Ana, CA (US)

Correspondence Address: SEED INTELLECTUAL PROPERTY LAW GROUP PLLC, 701 FIFTH AVE, SUITE 5400, SEATTLE, WA, 98104, US

(73) Assignee: THIN FILM DEVICES, INC., Anaheim, CA (US)

(21) Appl. No.: 12/210,993

(22) Filed: Sep. 15, 2008

(51) Int. Cl. G06F 3/044; G06F 3/041; B32B 27/14

(52) U.S. Cl. 178/18.06; 428/198; 345/173

(57) ABSTRACT

An electronic touch screen has a substrate having a glass transition temperature Tg below 300° C. The touch screen additionally has a first refractive index matched conductive layer formed on the substrate, a dielectric layer formed on the first index matched conductive layer, and a second index matched conductive layer formed on the dielectric layer. Further, the electronic touch screen has a set of contacts operatively coupled to the first and second index matched conductive layers, which are coupleable to an electronic circuit.

### BACKGROUND

1. Technical Field

Embodiments of touch screens disclosed herein relate to screens for electronic devices and, more particularly, to a screen with high light transmittance and reduced reflection.

2. Description of the Related Art

Electronic liquid crystal display (LCD) panels perform a variety of functions. LCD display panels are used in Global Position Satellite (GPS) systems, mobile phones, personal digital assistants (PDA), portable media players such as MP3 and other streaming audio/video equipment, cash registers, automated banking systems, vehicle dashboards, laptop computers, manufacturing equipment, and many other like devices and systems. In some cases, the displays are small, for example a display in a cellular phone. In other cases, the displays are large, for example, a television or other electronic monitor display mounted so as to be viewed by many people.

Electronic LCD panels are fabricated by layering materials having varying levels of opacity. In one of the layers, the liquid crystal (LC) layer, the opacity of some of the material within the layer is controllable. That is, based on how the LC layer is controlled, light is either permitted to pass through portions of the layer or blocked from passing through portions of the layer. This controlled passage of light through the layer permits an image to be formed on the LC layer's surface.

Further enhancement of the image on the controllable LC layer's surface makes it possible for a user looking through the LCD panel to clearly view the image. For example, colorization layers, polarization layers, and other layers are positioned in an LCD panel assembly to provide an enhanced viewing experience for the user.

In many applications, for example, personal media type devices and commercial/industrial equipment, an important part of the user interface is a touch screen. A touch screen is a generally transparent layer placed above the display layer. In some cases, the touch screen is configured as an integral part of an LCD display assembly, but in other cases, the touch screen is constructed separately and separately added to the stack of display components. When viewed from above, an image formed on the display surface is viewable through the touch screen.

The touch screen permits a user to directly contact the display's outer surface with a finger or stylus type device for the purpose of inputting control information into the device. Typically, the control information input by the user via the touch screen relates to the image displayed below the touch screen. In many cases, the control information consists of raw or formatted positional coordinates useful to identify where contact (i.e., touch) is made relative to the image viewable on the display.

In some cases, the touch screen is used to enter more information than just positional coordinates. For example, information associated with the duration of the contact with the touch screen, the direction of motion across the touch screen, the speed of the motion, and the downward pressure applied during contact may also be entered. In most cases, the input information from the touch screen is then processed, analyzed, and used to control the device.

In conventional a touch screens, electronic components are formed with high temperature processes on a glass substrate. The electronic components are resistive or capacitive elements formed in a predetermined pattern so that when an electric field applied to the elements is disrupted by a “touch,” information about the touch can be determined.

### BRIEF SUMMARY

An electronic touch screen formed on a substrate that requires low temperature processing is taught. According to one embodiment, the substrate is a plastic which cannot be subjected to high temperatures. For example, the plastic may have a glass transition temperature below 300° C. Therefore all processing of the substrate must be below this temperature to avoid melting the plastic. A first refractive index matched conductive layer having a selected pattern is then formed on the substrate, a dielectric layer is formed on the first index matched conductive layer, and a second index matched conductive layer is formed on the dielectric layer, all temperatures below the glass transition temperature of the plastic. Once completed, the touch screen is coupled to an electronic circuit via a set of contacts to provide the touch screen sensing.

According to another embodiment, an electronic touch screen having capacitive layers is formed on a plastic generally transparent means. The plastic generally transparent means is coated with a first conductor having a selected pattern. The first conductor is coated with a dielectric, and the dielectric is coated with a second conductor having a selected pattern.

### BRIEF DESCRIPTION OF THE SEVERAL VIEWS OF THE DRAWINGS

The components in the drawings are not necessarily drawn to scale relative to each other. Like reference numerals designate corresponding parts throughout the several views.

FIG. 1 is a cross-sectional diagram of a conventional thin film transistor (TFT) LCD display stack.

FIG. 2 illustrates a more detailed view of the known touch screen of FIG. 1.

FIG. 3 illustrates layers and locations in a common LCD display stack assembly where light is reflected back toward the surface of the assembly.

FIG. 4 illustrates a display assembly having a touch screen formed on a plastic substrate according to an embodiment of the present invention.

FIG. 5 illustrates a deposition apparatus useful for adding coatings to a touch screen substrate according to an embodiment of the present invention.

FIG. 6 illustrates a chamber with the temperature control structure spaced closer to the substrate according to an embodiment of the present invention.

FIG. 7 illustrates a patterning apparatus useful for producing patterned coatings on a touch screen substrate according to an embodiment of the present invention.

FIG. 8 illustrates one inventive embodiment of a touch screen having a substrate, a dielectric layer, and patterned conductive layers formed thereon.

FIG. 9 illustrates one embodiment of the inventive display stack assembly and layers and locations where light is reflected back toward the surface of the assembly.

### DETAILED DESCRIPTION

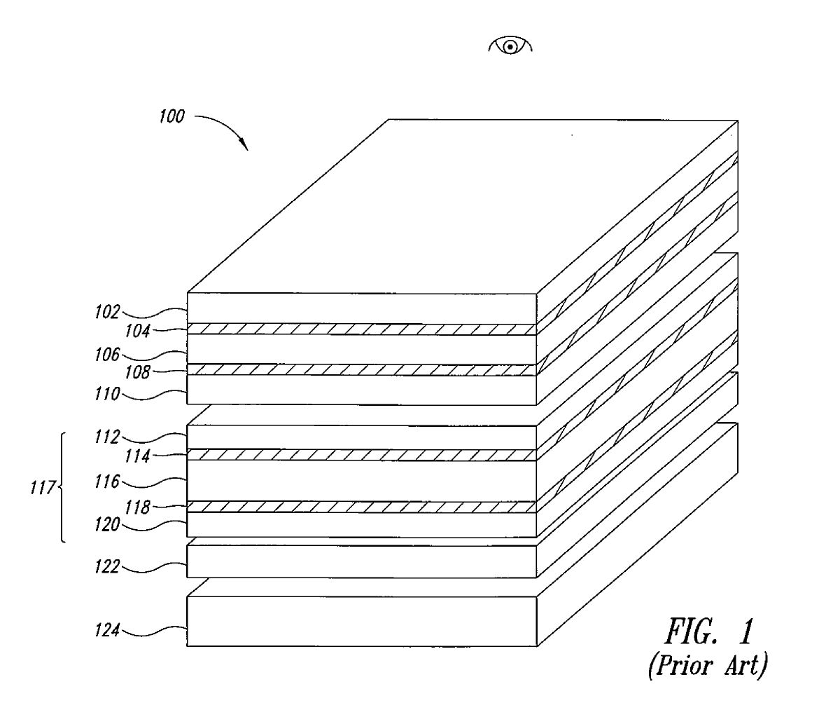

FIG. 1 is a cross-sectional diagram of a conventional thin film transistor (TFT) LCD display stack 100. A protective plastic bezel 102 is bonded to an anti-reflective (AR) glass 106 by an adhesive 104. The anti-reflective glass 106 is bonded to a touch screen 110 by an adhesive 108. An integral part of the LCD display stack 100 is the multi-layer LCD assembly 117. The LCD assembly 117 includes a first polarizer 112 bonded to an LCD 116 by an adhesive 114 and to a second polarizer 120 bonded by an adhesive 118.

In many common electronic devices, the LCD display stack 100 is mounted in a frame assembly that further comprises a light diffuser 122 and a light source 124. These are optional in some embodiments, but are provided in most color displays, such as an iTouch device, a computer screen, and the like. The entire LCD display stack assembly 100 consisting of the backlight 124, diffuser 122, LCD 116, and touch screen 110 are aligned and mounted in a chassis. The protective bezel 102 of plastic, glass, or other transparent material physically protects the LCD display stack assembly 100 from abusive contact and acts as an environmental barrier to keep undesirable material from entering the LCD display stack 100 chassis. Due to the transparency of protective bezel 102 and the other layers, the image formed on the LCD 116 is viewable through the bezel 102.

The AR glass 106 is a transparent sheet of glass having a reflection reducing optical coating applied to its surface. The optical coating improves the viewing experience for a user by reducing the amount of light that is lost on the downward and upward paths that light takes when traveling through the LCD display stack 100. Generally, the AR coating provides destructive interference of light beams reflected from the interfaces of different materials and constructive interference of the beams that are transmitted through the materials. Most simply, the AR glass replaces the air-bezel-display interface with two interfaces: an air-bezel-AR glass interface and an AR glass-display interface. The combined reflection of the two interfaces is less than the single interface.

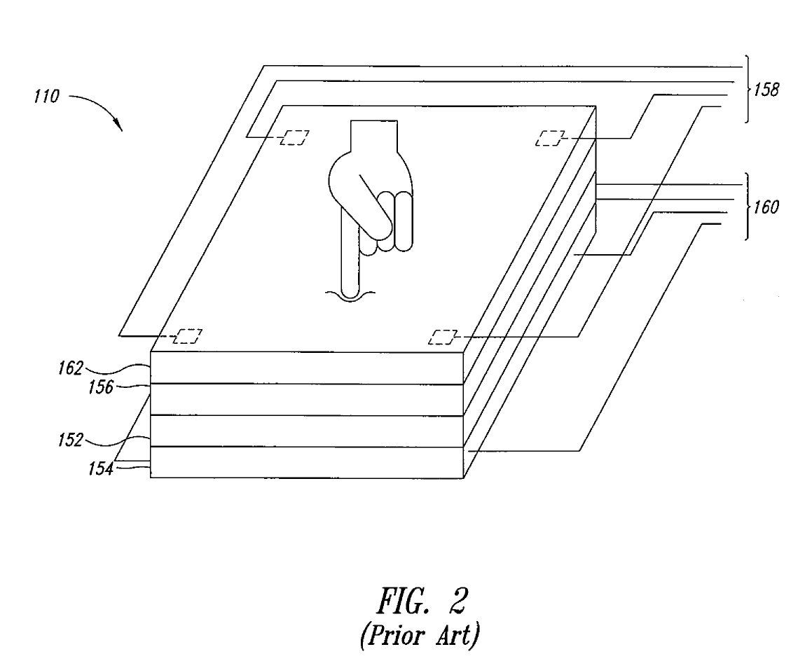

FIG. 2 illustrates a more detailed view of the known touch screen 110 of FIG. 1. One common form of touch screen, such as touch screen 110 embodied in FIG. 2, is a capacitive device formed as an independent structure. After formation, the capacitive touch screen is fixedly mounted above an LCD assembly 117. The touch screen structure 110 is formed from multiple layers.

In FIG. 2, glass substrate layer 152 is an integral part of the touch screen 110, and the glass layer 152 acts as a capacitive insulator. In such touch screens 110, the glass substrate layer 152 is transparent so that when the touch screen 110 is mounted above the multi-layer LCD assembly 117, images presented on LCD 116 are viewable by a user.

A uniform conductive layer 154 operates as a first capacitive conductor and another uniform conductive layer 156 acts as a second capacitive conductor. The conductive layers 154, 156 of the touch screen 110 are formed from an indium-tin-oxide (ITO) composition, however, many other conductive compositions could also be used. For example, compositions such as indium zinc oxide, aluminum zinc oxide, or other like composition may also be used to form the conductive layer. Ideally, the ITO composition provides superior electrical conductivity and optical transparency. In practice, however, a tradeoff is generally made between conductivity and transparency. That is, the more transparent the composition, the less conductive and vice versa.

Regarding transparency, the ITO composition must have some degree of transparency because the touch screen 110 is above the LCD assembly 117. The images displayed on an LCD 116 are viewed when the touch screen 110 and LCD assembly 117 are positioned one over the other.

Regarding conductivity, the ITO composition requires conductivity because the touch screen 110 is expected to efficiently and accurately measure points of contact. The capacitive effect enabled by the conductive ITO layers 154, 156 requires a charge moving material. That is, an integral part of any capacitor is the electrically conductive plates. In practice, when the plates of a capacitor are more conductive, then the capacitor is more electrically efficient, and the increased electrical efficiency improves the speed, accuracy, and power characteristics of the device.

The touch screen 110 embodied in FIG. 2 operates when low voltage signals are applied to multiple electrodes 158, 160 at the periphery of conductive ITO layers 154, 156. Current is sensed on multiple electrodes 156, 160 at the periphery of conductive ITO layers 154, 156, and the sensed current signals are analyzed to determine where the surface of the touch screen 110 has been contacted.

In operation, the small voltage applied to the electrodes 158, 160 produces a capacitive effect across the touch screen 110. A human body, which is an electrical conductor, draws a small amount of current from the conductive ITO layer 156 to ground during contact with the touch screen 110. The current drawn through each electrode 158 is proportional to the distance from the electrode 158 that the touch/contact is made. By measuring the currents drawn through electrodes 158 or 160, the location of the touch contact, relative to electrodes, can be mathematically determined. As an alternative to the solid plates shown in FIG. 2, the capacitive plates 154, 156 may be in the pattern of a grid, and the location of the touch may be determined based on the location of the touch on the grid.

A protective coating 162 is formed on top of ITO 156 of touch screen 110. The material, silicon dioxide or silicon oxide on glass (SOG) for example, is used to reduce the effects of abusive contact made with the touch screen 110 without destroying the capacitive properties of the touch screen 110.

Referring back to FIG. 1, currently used devices often have a light source 124 and a light diffuser 122 aligned below the LCD assembly 117. The light source 124, or backlight, generally provides light, which is passed or blocked by the individual pixels formed within the LCD 116 of the LCD assembly 117. The diffuser 122 is a layer of light conductive, translucent material that operates to evenly spread the light from the backlight with uniform luminance across the LCD assembly 117. The LCD assembly 117 operates in a known manner to provide a desirable image on the LCD 116.

As described previously, the individual layers of the LCD display stack assembly 100, such as those of FIGS. 1-2, are generally made from transparent materials. The layers vary in their level of opacity from completely transparent to nearly opaque, and more transparent layers are generally desirable. That is, when more light from the light source 124 is able to pass up through the LCD display stack assembly 100, then the presentable image formed on the top of LCD 116 is brighter, crisper, and generally of higher quality as perceived by a person viewing the image.

Referring again to FIG. 1, as light generated by a light source 124 passes up through the LCD display stack assembly 100, presentable images are formed on the LCD 116 surface. Also, as light passing down through the layers of the LCD display stack assembly 100 reaches the LCD 116 structure and is reflected back up through the layers, the images on the LCD 116 surface are viewable by a user. Ideally, all of the light passing down through layers of the LCD display stack assembly 100 would reach the LCD 116 structure. Nevertheless, the phenomenon of reflection limits the amount of light that penetrates each layer of LCD display stack assembly 100. Accordingly, the amount of light that reaches the LCD 116 surface is reduced.

Instead of reaching the LCD 116 surface, some of the light passing down through the LCD display stack assembly 100 is reflected back upward toward the surface of the assembly. This reflection occurs primarily at the interface points of the multiple layers of the LCD display stack assembly 100.

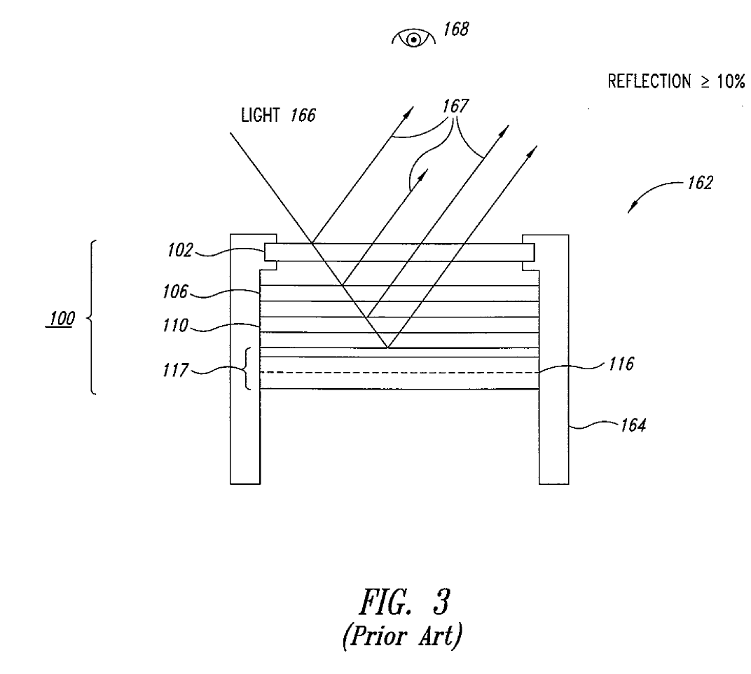

FIG. 3 illustrates layers and locations in a common LCD display stack assembly 100 where light is reflected back toward the surface of the assembly. The device 162 embodied in FIG. 3 may be any type of conventional electronic device using an LCD touch screen. In one embodiment, device 162 employs the LCD display stack assembly 100 of FIG. 1. The individual layers of FIG. 3 are distinctly illustrated for simplicity by separating each layer from adjacent layers. Some of the adhesive or other bonding structures that positionally align and retain the layers in typical devices are not shown for simplicity.

A chassis 164 in the device 162 mechanically supports the LCD display stack 100. The LCD display stack 100 has the protective bezel 102 and additional layers including anti-reflective glass 106, a touch screen 110, and an LCD assembly 117.

During operation of device 162, ambient light 166 from outside the device 162 passes down through the layers of the LCD display stack assembly 100 toward the surface of the LCD 116. Ideally, all of the ambient light 166 will reach the LCD 116 surface and then some or all of the light is reflected back toward the user 168 such that an image formed on the LCD 116 is clearly viewable. In most cases, however, some of the ambient light 166 is reflected back upwards before the light 166 ever reaches the LCD 116 layer.

When light is reflected back from the layers within an LCD panel assembly, the image viewable on the assembly is degraded. Most often, the image appears dim and grainy and in some cases, the image is not viewable at all. The undesirable effect of reflection is especially apparent when the LCD panel is integrated into a device that is used under bright lights, e.g., sunlight, manufacturing floor, bank or other financial or high security setting, etc. Reflection in these environments can overwhelm the image presented on the LC layer making the device difficult or even impossible to view.

As light 166 enters the device 162 at the interface between the outside environment and the plastic bezel 102, some of the incoming light 166 is reflected back toward the outside environment as noise or glare light 167. Light 166 is reflected back at each interface between the layers of the LCD display stack 100 within device 162 creating many locations of glare 167. As more light 166 is reflected back as glare light 167 prior to reaching the surface of the LCD 116, the viewing quality of the image continues to significantly decline. That is, the reflected components of light 166 detrimentally affect how well the image presented on the surface of the LCD 116 is viewable by a user 168. As the amount of light reflected continues to increase, the quality of the viewable image continues to decrease.

The amount of light reflected away before reaching the LCD 116 is generally attributable to the different indexes of refraction of the raw materials of the different layers, and the reflection is most pronounced at the interfaces of adjacent material layers. Further, once the layers are bonded together, even the minute surface imperfections, such as micro-scratches, present interfaces of differing indices of refraction between the layers. In some cases, 10% or more of the light 166 striking the surface of the LCD display stack assembly 100 is reflected back.

The index of refraction of each layer is a measurement of the speed of the light 166 passing through the layer. When adjacent materials have widely disparate indices of refraction, the amount of light 166 that is reflected is greater. For example, when an image is viewed through a sheet of clear glass, a certain amount of light will be reflected by the clear glass. The reflection is, in some part, due to the mismatch of indices of refraction between the ambient air, which has an index of refraction of about 1.0, and the clear glass, which has an index of refraction of about 1.51.

One known way of reducing the total reflection of the LCD display stack assembly 100 is to match the indices of refraction of adjacent layers in the stack as closely as possible. Generally, this is accomplished by creating several layers of transparent thin film structures.

Where two adjacent light transmitting layers have different indices of refraction, the reflection of the stack is reduced when a thin layer of material having a particular third index of refraction is placed between them. More specifically, if a first layer has a refractive index of I₁, and a second layer has a refractive index of I₂, then reflection is reduced by placing a thin layer between the first two layers, wherein the third layer has a refractive index I₃ that satisfies the equation:

I₃=\sqrt{I₁I₂}

Ambient air around a device has a refractive index of about 1.0, transparent plastic bezels have a refractive index of about 1.58, and clear glass panels have a refractive index of about 1.5. Conductive ITO layers, such as those used in the touch screen of FIG. 2, have a refractive index of about 2.0. If index matching layers are formed between the interfaces of adjacent glass, plastic, and ITO materials, then the total reflection of an LCD display stack may be reduced.

Unfortunately, the addition of the index matching layers adds further cost to an LCD panel. Several additional processes to form the layers are required, and additional materials beyond those necessary for forming a typical, non-index matched display must be used. The additional processing steps, the additional equipment to perform the steps, and the material for the extra layers all add to the cost of the display assembly.

Instead of index matching layers, some manufacturers choose to increase the light output from the light source in order to reduce the effects of reflection. Other manufacturers use fewer layers, for example, they do not provide a touch screen in the device. Removing layers will reduce the amount of reflection, but it will also reduce the functionality available from the device. Accordingly, a technique to reduce reflection in an LCD panel without increasing cost or reducing functionality would benefit manufacturers and users of electronic devices having LCD panels.

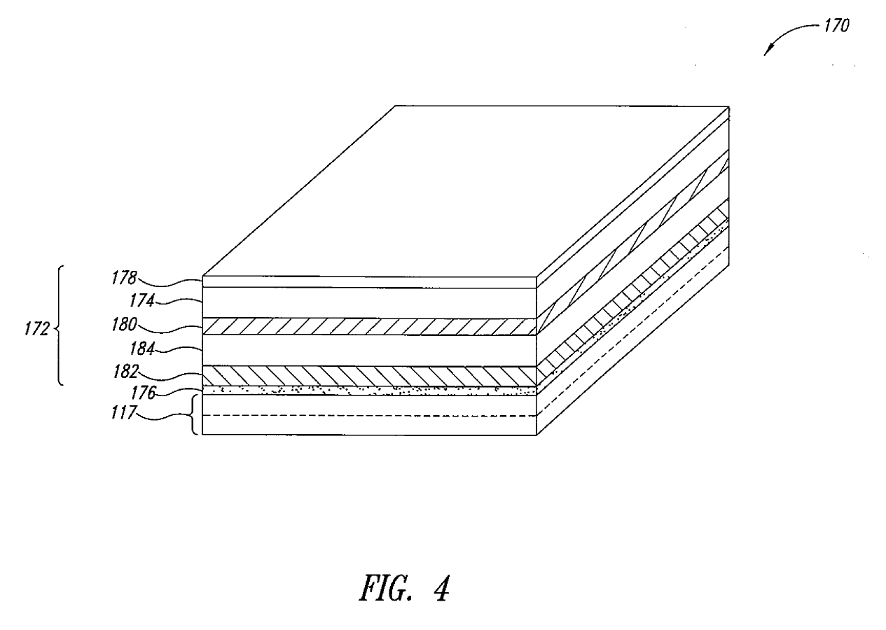

FIG. 4 illustrates one embodiment of the invention of a display assembly 170 having a touch screen 172 formed on a plastic substrate 174. The display assembly 170 also has a conventional LCD assembly 117 joined to the touch screen 172 by an adhesive 176. Generally speaking, the entire display assembly 170 is constructed of two panels, the touch screen 172 and the LCD 117, joined by an adhesive 176.

The display assembly 170 of FIG. 4 satisfies the goals of low reflection and high contrast. The display assembly 170 further satisfies the goals of low cost and high functionality. In particular, substrate 174 is hard enough such that the need for the protective plastic bezel of conventional display assemblies is eliminated. An antireflective or index matched coating 178 is provided on the substrate 174, therefore the need for the separate anti-reflective glass of previous assemblies is eliminated. Accordingly, the cost of display assembly 170 is reduced because the production and material costs of the protective bezel and anti-reflective glass are eliminated.

Touch screen 172 of FIG. 4 is formed by adding one or more index matched coatings of material to substrate 174. These are very thin coating layers, as compared to the separate glass or sheet layers of the prior art. On the first side of the substrate 174, an anti-reflective coating 178 is provided. On the second side of the substrate 174, first and second conductive layers 180, 182 separated by a dielectric layer 184 are provided.

Substrate 174 is a sheet of nearly or completely transparent plastic material. As distinguished from conventional glass substrates, plastic substrate 174 is generally more pliable, less brittle, lower in cost, and it must be processed at much lower temperatures than a glass substrate. One problem with using plastic has been that the manufacturing steps for the coating and layers require high temperatures, usually over 400° C., but plastic cannot survive these high temperatures. In a preferred embodiment, the processing temperature of substrate 174 does not exceed 60° C. The low processing temperature of the substrate 174 material is amenable to deposition of both solid and patterned layers of various materials on the substrate's surface using the techniques described herein. In a preferred embodiment, the glass transition temperature Tg of substrate 174 is below 300° C.

In some embodiments, substrate 174 is made from a sheet of organic or synthetic, polymerized material. Such materials are broadly identified as “plastic.” Nevertheless, substrate 174 may be made from any low Tg material that is light-transmissive, stable, and capable of bonding to conductive, dielectric, and index matching materials.

In a preferred embodiment, substrate 174 is formed of allyl diglycol carbonate. Allyl diglycol carbonate, commonly known as COLUMBIA RESIN (CR)-39, is a suitable material for substrate 174. The poly-carbonate, CR-39, is transparent in the optical spectrum (approximately 380 nm-750 nm), and CR-39 has an index of refraction of about 1.50-1.60. Further, CR-39 is very hard, which makes it well suited as an abrasion-resistant surface of a touch screen.

In another preferred embodiment, substrate 174 is formed of polymethyl methacrylate (PMMA). PMMA is a low-cost transparent, synthetic thermoplastic having an index of refraction of about 1.50-1.60. PMMA is not has hard as CR-39, however, PMMA is nevertheless suitable as a substrate. In many cases, PMMA touch screens will be operated with lower impact utensils, such as fingers or soft-tipped styluses. In some cases, an additional hardness coating may be applied to a PMMA substrate.

Although plastic substrates tend to be less environmentally stable than glass substrates, plastic substrates have some benefits not found in glass substrates. For example, plastic substrates are relatively inexpensive compared to glass. Plastic substrates are more easily formed, molded, and shaped than glass, and further, the low-temperature processing of plastic is more energy efficient than the high-temperature processing of glass.

One main source of plastic's environmental instability is that a plastic substrate is not 100% solid. Instead, the plastic material is a tightly formed collection of fibrous materials having micro cavities between the fibers. The micro cavities in the plastic substrate absorb water moisture easily and quickly. In some cases, up to 3% of the plastic substrate's volume is comprised of water vapor.

When the plastic outgases water vapor, the plastic tends to break down. This problem is especially acute in a vacuum, which is the environment where layers are formed on the substrate. Hydrocarbon bonds, which are an elemental structure of the plastic, are weakened in the vacuumed chamber. When the weakened bonds break, then the structural and optical properties of a plastic substrate are degraded. Accordingly, changing atmospheric conditions will affect how pliable, how transparent, and/or how dimensionally constant a plastic substrate will remain during processing. Steps can be taken so that the water content of the pre-processed plastic substrate is controlled and the factors which affect the water content of the substrate during processing can also be controlled.

Prior to forming any coatings on substrate 174 of FIG. 4, the substrate raw material is subjected to an out-gassing step. The purpose of the out-gassing step is to put substrate 174 into a known state for additional processing. Differing levels of water absorption amongst samples negatively affects how consistently and how well later added materials will bond to the substrate and how well the finished touch screen 172 will perform.

The out-gassing step consists of subjecting the substrate 174 to a predetermined temperature and a predetermined relative humidity for a predetermined time. For example, locating the substrate in an environment of 70° C. and 35% relative humidity for 2 hours will cause water vapor to either be absorbed in the substrate or released by the substrate. It is understood that a longer or shorter time period, a different relative humidity, and/or a different duration of time may also be found acceptable. Additionally, performing the out-gassing step at a predetermined atmospheric pressure may also provide favorable results. A lower pressure than atmospheric may speed the process or permit use of lower temperatures.

The out-gassing step leaves weakly bonded carbon atoms on the surface of the substrate 174. The carbon atoms at the surface tend to inhibit bonding of any other atmospheric impurities, which would lead to inconsistencies and/or failures in later added layers. After the out-gassing step, the substrate 174 is ready for further preparation prior to the formation of anti-reflection and touch-screen layers.

Substrate 174 is subjected to an ion etch clean step. The ion or plasma etch cleaning process is performed after placing the substrate in a vacuumed environment. As is known to those skilled in the art, the etch-cleaning process generally comprises bombarding the substrate with gaseous argon, oxygen, or other ions for several minutes to remove the residue of the outgas step. In a preferred embodiment, the ion etch clean step lasts for 3-5 minutes.

Subsequently, index matched coatings of various materials are applied to the substrate 174 via one or more deposition processes. For example, physical vapor deposition processes (PVD), chemical vapor deposition (CVD) processes, or thermal evaporation (ion beam sputtering) processes may each be used. In addition, other techniques known to skilled artisans may also be used to apply the coating.

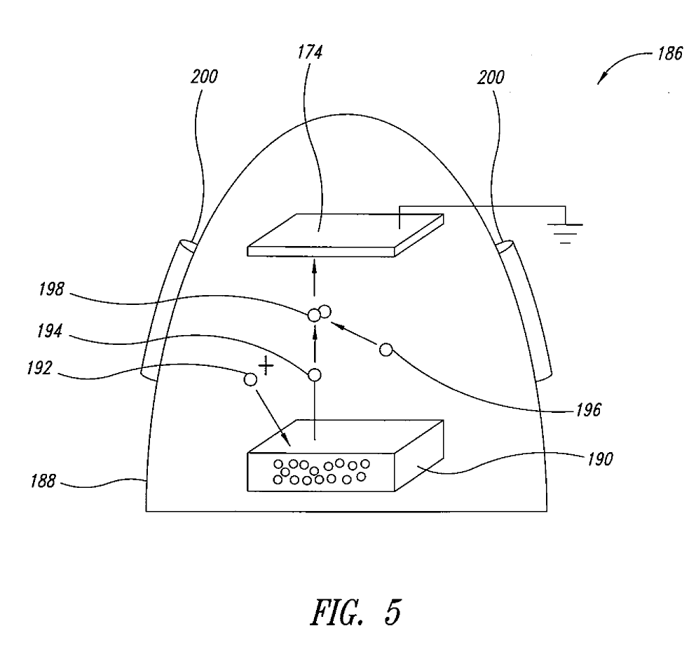

FIG. 5 illustrates a deposition apparatus 186 useful for adding coatings to a touch screen substrate 174. Basically, substrate 174 is placed in the hollow cavity of a sealable chamber 188 along with a target of material 190 to be used as the coating, for example niobium, hafnium, titanium, tantalum, indium, tin, aluminum, combinations thereof, or the like. During the deposition process, ion beams 192 knock particles 194 from the pure material target and release them into the chamber 188. The particles 194 of target material, individually or bonded with gaseous particles 196, are then attracted to the substrate 174 and deposited on the substrate's surface.

More particularly, in a first step of a deposition process, once the substrate 174 and target material 190 are located in the chamber 188, ambient air is removed from the chamber 188 leaving the target 190 and the substrate 174 in a vacuum. An inert gas, such as argon, is then introduced into the chamber, and in some cases, an active gas, such as oxygen, is also introduced. The substrate material 174 is electrically grounded, and a high negative voltage is applied to the target 190. The high negative voltage ionizes the argon gas, which produces positively charged argon ions 192. Excited argon ions 192 strike the target material 190 and the transfer of kinetic energy knocks particles 194 of material from the target 190. In this embodiment, atoms of the target material 194 bond with one or more atoms of oxygen 196 and the new oxide molecule 198 is electrically drawn toward the grounded substrate 174. As the process continues, molecules 198 are deposited on the substrate material and the desired layer is formed.

By controlling system parameters such as voltage, current, temperature, and time, the specific layers can be uniformly deposited on the substrate, and the layers can be formed having a desirable composition. In some cases, the system parameters of the deposition process are predetermined, and in other cases, feedback from the process is dynamically used to control the process.

As mentioned herein, in an embodiment, the substrate 174 is plastic and has the characteristic of a low glass transition temperature Tg. As also mentioned herein, substrate 174 is environmentally sensitive to water vapor, particularly during processing. Thus, it is possible that during deposition processes, substrate 174 will outgas water further as the process continues. In some instances, temperature control of the substrate 174 is used.

In order to control temperatures of the substrate 174 during deposition processing, some temperature control means 200 are used to keep the deposition chamber 188 at one or more predetermined temperatures. In an embodiment, the temperature control means include water cooling tubes located around the chamber 188. In some cases, the temperatures of multiple areas of the chamber 188 are independently controllable.

The location of the substrate 174 relative to the target and the cooling source of the temperature control 200 is selected to maintain the substrate 174 within a desired temperature. In one example of deposition process control, different areas of the deposition chamber 188 will reach different temperatures during the process. When the substrate 174 and the target material 190 are first placed in the chamber 188, both the substrate 174 and the target material 190 will be at the same temperature, usually room temperature, such as 30° C. As the ionization and deposition processing progresses, the temperature of the target material 190 may range from 200 to 800° C., or even higher. In some cases, the target material may be heated to induce vaporization. Desirably, however, the substrate 174 temperature should be substantially maintained at 40 to 60° C. in order to preserve the structural, optical, and chemical integrity of the substrate 174.

Therefore, the substrate 174 is placed some distance from the target to reduce the temperature affects from the target to the substrate. The heat produced at the target material 190 is dissipated by introducing a cooling agent via the temperature control means 200. For example, by cycling water around the outside of the chamber, the temperatures within the chamber can be maintained in equilibrium. The equilibrium of temperatures is useful to create uniformity of the deposed layers, which increases yield of the final product.

In some cases, cycling the cooling agent through the temperature control means 200 is a dynamic process that uses feedback from sensors within the chamber 188. The temperature in the chamber is controlled by altering the pressure and/or temperature of the cooling agent. In other cases, cycling the cooling agent through the temperature control means 200 is a static process. That is, instead of altering the characteristics of the cooling agent, the ionization process is adjusted by controlling time, voltage, and/or current. In still other cases, a particular “recipe” is developed having predetermined parameters. The parameters of timing, voltage, and current are pre-set for a given process in a given machine, such that when the recipe is followed, favorable yields are produced.

The temperature of the substrate can also be monitored to ensure it stays within acceptable ranges. For example, an IR sensor or other remote sensor can be used to determine the temperature of the substrate 174. In addition, the temperature control means 200 can be spaced adjacent to the substrate 174, but far from the target 190, to permit the target to heat up and to keep the substrate 174 cool. Usually, the temperature control means 200 will be outside the chamber to avoid contamination of the process, but in some cases, parts of the temperature control means 200 can be within the chamber itself.

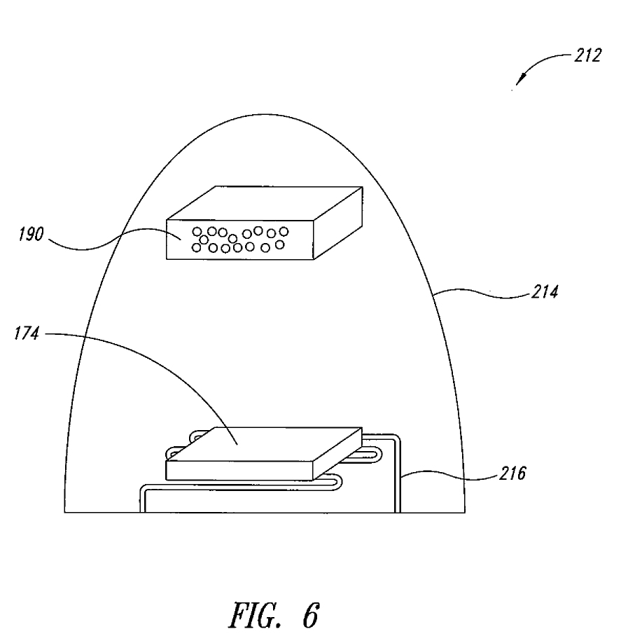

FIG. 6 illustrates a deposition apparatus 212 different than the deposition apparatus 186 of FIG. 5. Deposition apparatus 212 has a deposition chamber 214 with the temperature control structure 216 spaced closer to the substrate 174. The distance of the temperature control structure 216 has little effect on the deposition rate, but the distance has a large effect on the substrate 174 temperature. Additional active structures within the deposition chamber 214 are not shown for simplicity.

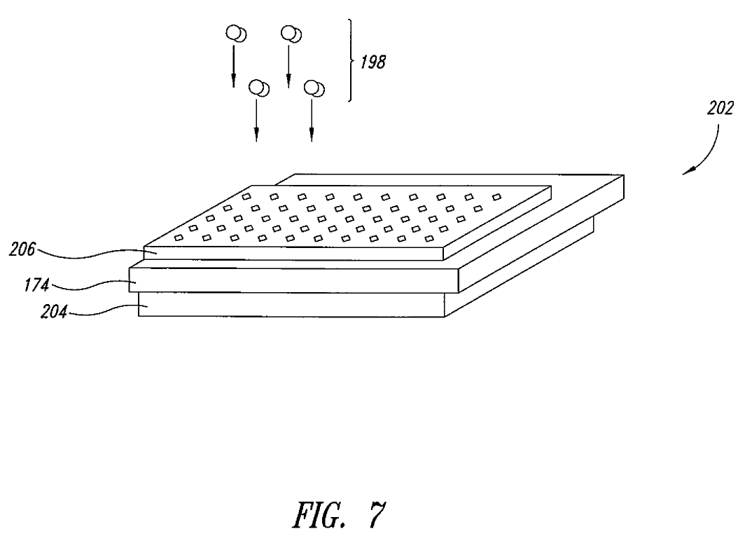

FIG. 7 illustrates a patterning apparatus 202 useful for producing patterned coatings on a touch screen substrate 174. In some cases, as described herein, it is useful for a particular layer on a substrate 174 to have a predetermined pattern, such as a grid, and in other cases a blanket layer is preferred. A grid pattern selectively includes deposited material on some parts of the underlying layer while selectively excluding deposited material from other parts of the underlying layer. Alternatively, a blanket layer completely covers the underlying layer. Several techniques known to those skilled in the art are possible, one of which is the patterning apparatus 202 of FIG. 7.

In the patterning apparatus 202, substrate 174 is placed between a magnetic base 204 and a ferrous stencil mask 206. The mask 206 is attracted to the magnet 204, which ensures a firm and consistent temporary bond between the mask 206 and the surface of the substrate 174. In some cases, the magnetic base 204 is an electromagnet so the attraction strength of the ferrous mask 206 is controllable.

During the deposition process, the patterned mask 206 serves to block the target material molecules 198 from bonding to the surface of the substrate 174 in areas where the pattern mask 206 is solid, and to permit the bonding of molecules 198 in areas where the mask is open. The patterned stencil mask may be created by laser etching or some other means, and patterns of any shape and size may be created on the substrate 174. After the pattern in the desired shape is created, the patterning apparatus 202 may be removed from the chamber.

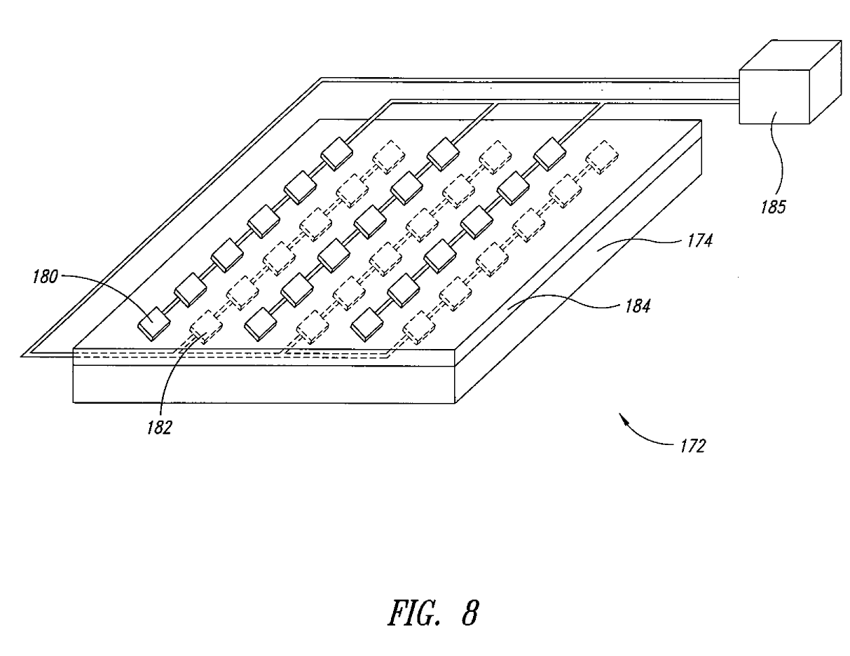

FIG. 8 illustrates one embodiment of a touch screen 172 having a substrate 174, a dielectric layer 184, and patterned conductive layers 180, 182 formed thereon. The patterns shown in FIG. 8 are merely representative of an infinite number of patterns creatable during the manufacture of a touch screen. The patterns 180, 182 shown in FIG. 8 may be formed with the aid of the patterning apparatus 202 illustrated in FIG. 7, or the patterns may be created with any other means known to those skilled in the art. For example, low temperature photo etching may also be used. In such cases, patterns 180, 182 may be formed of a particular conductive material, such as ITO, and the patterns 180, 182 may also be index matched with adjacent materials. Further, patterns 180, 182 may have shapes down to 5 microns or less and may also have conductive traces run out to the borders of the substrate 174.

In some cases, the conductors terminate at the edge or edges of the touch screen 172 as a set of contacts having a particular pattern, and in other cases, the conductors are merely a set of metalized contacts. The type of contacts used help device manufacturers during assembly. That is, in some cases, the contacts are used as an integral part of an electromechanical assembly, and in other cases, the contacts are merely electrically coupled to an external cable, connector, zebra pad, or the like.

The patterns 180, 182 of conductive material are often coupled to an electronic circuit 185 of a particular electronic device. The electronic device has an LCD and touch screen assembly such as assembly 170 of FIG. 4. During operation, the electronic circuit charges and senses the charge shift in the touch screen 172 in order to provide user input to the electronic device.

Referring back to FIG. 4, a preferred embodiment of a touch screen 172 is now described. After performing the out-gassing and ion etch cleaning steps described above, certain layers for touch screen 172 are formed on substrate 174.

Substrate 174 is preferably between 0.7 mm and 1.1 mm thick. Generally speaking, a thinner substrate is preferable for better optical performance; however, substrate 174 requires both flexibility and rigidity in order to provide the good mechanical stability needed in a touch screen. Thus, in some cases, for example, where the touch screen is small, substrate 174 will be thinner than 0.7 mm. In other cases, for example, where the touch screen is large, substrate 174 will be thicker than 1.1 mm.

A first index matched conductive layer 180 is formed on the substrate 174 using a low temperature deposition process. In a preferred embodiment, the first index matched conductive layer is niobium oxide (Nb₂O₃); however other materials may be used. Niobium is chosen for its low reflectivity and conductive properties, which permits thin, light transmissive coatings to be formed as the conductive plates of a capacitive touch screen. Other materials having similar properties, for example, titanium, hafnium, and tantalum, may also be used.

The niobium oxide layer desirably has an index of refraction of about 1.95-2.05, however, the actual index of refraction of the layer is closely related to the deposition temperature, rate, and background oxygen pressure. When these deposition parameters and the deposition environment are specifically controlled, as described above, the index of refraction is correspondingly well controlled to have the desired value that closely matches the substrate 174.

Conductive layer 180 preferably has an end-to-end electrical resistance of 10 Kohms or less, however, the final end-to-end resistance is dependent upon the achieved ohms-per-square and the dimensional size of the layer. That is, the ohms-per-square value achieved is dependent on the material used to make conductive layer 180, the uniformity of the layer, and the thickness of the layer. Thicknesses of 2000 to 3000 Å are common, however layers of greater and lesser thickness is also permitted. Generally, as the length and/or width of the touch screen increases or decreases, the thickness of the conductive layer 180 will proportionally follow.

Dielectric layer 184 is formed on conductive layer 180. In a preferred embodiment, a thick 1 to 2 micron layer of silicon dioxide (SiO₂) is used as a dielectric material because of its well known insulating properties, but other insulating materials may also be used. The dielectric layer 184 can be deposited on the substrate using techniques described above; however, other sputtering techniques, spin-on techniques, or other deposition processes known in the art can also be used.

A second index matched conductive layer 182 is formed on dielectric layer 184. The second conductive layer 182 is preferably formed with the same process and materials as the first conductive layer 180; thus the second conductive layer 182 has substantially the same index matching and electrical characteristics as the first conductive layer 180. In other embodiments, the second conductive layer may be formed with different materials. That is, in some cases, index matching of the entire touch screen structure may be better served by conductive layers 180, 182 of different formulation.

The second conductive layer 182 may be patterned in a similar pattern as, or differently from, the pattern of the first conductive layer 180. For example, FIG. 8 illustrates that in some embodiments, the first conductive layer 180 forms a set of diamond shaped “column” elements, and the second conductive layer 182 forms a set of diamond shaped “row” elements. Other shapes and patterns, for example dots, concentric circles, polygons, triangles, and any other shape or pattern may also provide favorable results. Further, FIG. 8 illustrates that in some embodiments, each of first and second conductive layers 180, 182 are formed on separate sides of dielectric layer 184. In some embodiments, first and second conductive layers 180, 182 can be formed on the same side of dielectric layer 184, and alternatively, a single conductive layer having electrically isolated interlaced patterns can be formed with the appropriate electrical connections to sense finger locations.

In other words, the touch screen described herein is not limited to any particular pattern with regards to the conductive layers. Instead, the low temperature formation of index matched conductive layers on a substrate such as plastic can be of any desirable shape and pattern.

During another step of the deposition process, an anti-reflection coating 178 may be added to the substrate 174, but this is optional. The anti reflective coating, for example, magnesium fluoride MgF₂, can be added to reduce the glare caused by ambient light striking the surface of substrate 174. In addition to being amenable to the low temperature deposition processes required by substrate 174, MgF₂ has an index of refraction of about 1.392, which is useful to index match substrate 174 as a coating to reduce glare in an ambient air environment where the touch screen 172 will be operated.

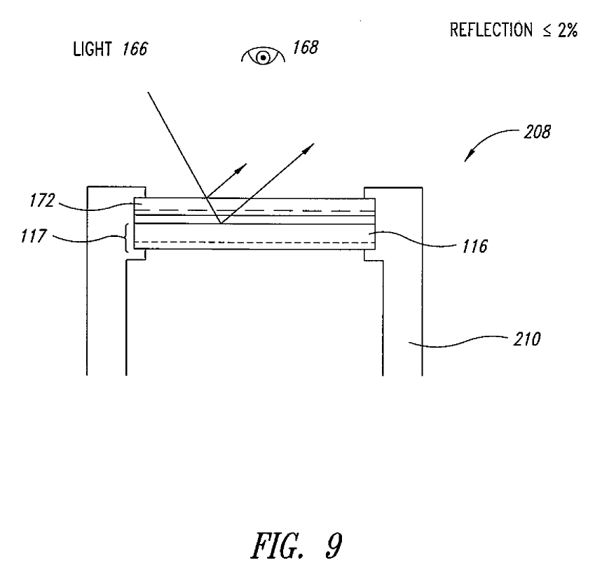

FIG. 9 illustrates one embodiment of a new display stack assembly 208 and layers and locations where light is reflected back toward the surface of the assembly 208. The display assembly 208 of FIG. 9 is contrasted with the display assembly 162 of FIG. 3. FIG. 9 illustrates that the reduced number of layers in the new display assembly 208 and the low temperature index matched layers of the touch screen 172 considerably reduce the total amount of reflection of light from the assembly. That is, whereas the conventional display assembly 162 has a total reflection of up to 10% or more, the reflection in the new display assembly 208 is substantially less. In some cases, the new display assembly has a total reflection of less than 2%. Accordingly, display assembly 208 is advantageous because it provides a brighter, crisper, high contrast display, particularly in bright light. Further, display assembly 208 uses lower cost materials, lower cost production methods, and may also provide more efficient use of power in systems where it resides.

The device 208 embodied in FIG. 9 may be any type of electronic device. Preferably, device 208 employs the LCD display stack assembly 170 of FIG. 4. The individual layers of FIG. 9 are distinctly illustrated for simplicity by separating each layer from adjacent layers. The adhesive or other bonding structures that positionally align the layers in typical devices 208 are not shown for simplicity.

A chassis 210 in the device 208 mechanically supports the LCD display stack 170. Further, the touch screen 172 provides the additional functionality of a protective barrier between the circuitry inside of chassis 210 and the external environment.

During operation of device 208, ambient light 166 passes down through the layers of the LCD display stack assembly 117 toward the surface of the LCD 116. In the embodiment of FIG. 9, more light 166 reaches the LCD 117 than in previous devices. Accordingly, more light 166 is desirably reflected from the LCD 116 surface and an image formed on the LCD 116 is more clearly viewable by a user 168.

Touch screens having patterned layers, such as those of FIG. 8, are generally useful in new display devices, for example device 208. Flexible trace cable contacts are positioned on the edge of the touch screen 172 to make electrical connection to the metalized edge of the touch screen 172. In operation, the touch screen is charged and sensed with integrated or external electronic circuits 185. The electronic circuits 185 are used to identify the location, duration, pressure, and other characteristics of a particular contact. Electronic circuits 185 are well known in the art, and the details need not be provided because any such known circuits can be used.

More particularly, when electronic circuitry operates the touch screen 172 capacitively, a human finger contact with the surface of the screen disrupts the capacitive equilibrium of the touch screen. The particular signals sensed are electronically processed to determine the location and characteristics of the touch. For example, a particular row and column coordinate can be calculated. Additionally, some systems also calculate the duration of the touch, the motion of the touch across the screen, the pressure of the touch, and other characteristics. Most often, the calculated touch position is useful in cooperation with the image presented on the underlying LCD 116. There is, therefore, coordination between the touch screen grid and the LCD image as is also well known in the art.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An electronic touch screen component, comprising:
a light transmissive substrate having a glass transition temperature below 400° C.;
a first light transmissive, refractive index matched conductive layer formed on the substrate;
a light transmissive dielectric layer formed on the first index matched conductive layer;
a second light transmissive, index matched conductive layer formed on the dielectric layer; and
a plurality of contacts including a first contact operatively coupled to the first conductive layer and a second contact operatively coupled to the second conductive layer, wherein the plurality of contacts are adapted to be coupled to an electronic circuit.

2. The electronic touch screen component of claim 1 wherein the substrate is comprised substantially of plastic.

3. The electronic touch screen component of claim 2 wherein the plastic substrate is comprised substantially of allyl diglycol carbonate.

4. The electronic touch screen component of claim 2 wherein the plastic substrate is comprised substantially of polymethyl methacrylate.

5. The electronic touch screen component of claim 1 wherein the total reflectivity of the electronic touch screen component is less than about 2%.

6. The electronic touch screen component of claim 1 wherein a first element of the first refractive index matched conductive layer is selected from the group consisting of niobium, hafnium, indium, tantalum, and titanium.

7. The electronic touch screen component of claim 6 wherein a second element of the first refractive index matched conductive layer is oxygen.

8. The electronic touch screen component of claim 6 wherein the primary element of the first refractive index matched conductive layer is niobium.

9. The electronic touch screen component of claim 1 wherein the first refractive index matched conductive layer is patterned.

10. A touch screen, comprising:
plastic translucent means for supporting capacitive layers of the touch screen;
translucent first conductive means coated on the plastic translucent means for forming a first plate of a capacitor;
translucent dielectric means coated on the first conductive means for forming a dielectric of the capacitor; and
translucent second conductive means coated on the dielectric means for forming a second plate of the capacitor.

11. The touch screen of claim 10 wherein the plastic translucent means is allyl diglycol carbonate.

12. The touch screen of claim 10 wherein the plastic translucent means is polymethyl methacrylate.

13. The touch screen of claim 10 wherein the first conductive means and the second conductive means have niobium as a first electrical conductor.

14. The touch screen of claim 10, further comprising:
means for electronically coupling the first and second conductive means to electronic circuitry.

15. The touch screen of claim 14, further comprising:
electronic circuitry means for capacitively driving and sensing the first and second conductive means.

16. The touch screen of claim 10 wherein the first and second conductive means and the dielectric means are index matched such that the total reflectivity of the touch screen is less than 3%.

17. The touch screen of claim 10 wherein the first and second conductive means and the dielectric means are index matched such that the total reflectivity of the touch screen is less than 2%.
